(19) United States
(12) Patent Application Publication
(10) Pub. No.: US 2006/0207399 A1
(43) Pub. Date: Sep. 21, 2006

(54) BLIND PACKAGING AND METHOD OF CUTTING BLINDS

(76) Inventors: Clifford Birch, Summerfield, NC (US); Thomas Caputo, Greensboro, NC (US)

Correspondence Address: MOORE & VAN ALLEN PLLC, P.O. BOX 13706, Research Triangle Park, NC, 27709, US

(21) Appl. No.: 10/908,728

(22) Filed: May 24, 2005

Related U.S. Application Data
(60) Provisional application No. 60/594,175, filed on Mar. 16, 2005.

(51) Int. Cl. B26D 7/02

(52) U.S. Cl. 83/13; 83/451

(57) ABSTRACT

The ends of a blind are aligned in a package by the manufacturer during the packaging process. The blind is secured in the package such that the blind elements cannot move from the aligned position. The aligned blind and the packaging are inserted into a cutting machine at the point of purchase and the cutting machine cuts the blind and the packaging simultaneously. Because the blind is secured in the aligned position by the packaging, the blind remains aligned during the cutting process.

### CROSS REFERENCE TO RELATED APPLICATIONS

This application is a non-provisional patent application of Ser. No. 60/594,175, filed Mar. 16, 2005, entitled “Blind Packaging and Method of Cutting Blinds”, which is incorporated herein in its entirety by reference and claims the benefit of the filing date of provisional application Ser. No. 60/594,175 under 35 USC §119(e).

### BACKGROUND

The invention relates generally to window blinds that can be cut-to-size at the point of sale and more particularly to packaging that facilitates accurate cutting of the blinds and a method of cutting blinds using the packaging.

It will be appreciated that window blinds come in a variety of materials including wood, plastic, fabric, vinyl and aluminum and a variety of styles including horizontal, woven, pleated, Roman and cellular. Blinds are sold as stock, custom and size-in-store. Stock blinds are manufactured in a variety of standard widths that are intended to fit corresponding standard window sizes. The end user purchases the blind at a retail outlet in the size that most closely matches the window on which the blind is to be used. Custom blinds are manufactured to a specified size per an end user's specific request. A third type of blind is known as size-in-store, where the blinds are manufactured in a limited number of sizes that are intended to be used with a wide range of window sizes. A cutting machine is provided in at the point of sale that cuts the blind from the manufactured size to the end user's desired size. The cutting machine can be operated by the retail outlet personnel and is simple enough to operate with little or no training.

The cutting machines operate with sufficient accuracy for a variety of materials and styles; however, the cutting machines cannot accurately cut all types of blinds. It will be appreciated that in order to obtain a straight cut along the edge of the blind, the blinds must be properly aligned in the cutting machine such that the edge of the blinds elements, such as slats, head rail and bottom rail, are in a common plane. For certain types of blinds the existing method and apparatus for cutting the blinds is adequate. For other types of blinds such as faux woven blinds, the existing cutting method and apparatus does not result in a straight edge. The inaccuracy of the cut is a result of inability of the operator of the cutting machine to properly align the edges of the blind and maintain that alignment throughout the cut. With certain blind styles and materials alignment of the blind elements is more difficult.

Thus, an improved method and apparatus for accurately cutting size-in-store blinds is desired. SUMMARY

The invention consists of packaging the blinds in such a manner that existing cutting machines can accurately cut the blinds at the point of purchase. The ends of the blinds are aligned in a package by the manufacturer during the packaging process. The blinds are secured in the package such that the blind elements are fixed in the aligned position. The aligned blinds and the packaging are inserted into the cutting machine as a unit and the cutting machine cuts the blinds and the packaging simultaneously. Because the blinds are secured in the aligned position by the packaging, the blinds remain aligned during the cutting process. In one embodiment the blind is placed in a cardboard package and the ends of the blind top rail, bottom rail and slats are aligned in a common plane. Once aligned, the package and blind are shrink wrapped such that the blind elements are fixed in the package.

### BRIEF DESCRIPTION OF THE DRAWINGS

FIG. 1 is a perspective view showing a woven blind.

FIG. 2 is a perspective view showing the package for the blind.

FIG. 3 is a perspective view showing the package with the blind located therein.

FIG. 4 is a perspective view showing the package and blind with shrink wrap.

FIG. 5 is a perspective view showing the apparatus for packaging the blind in the package.

FIGS. 6 through 11 are perspective views of different embodiments of the package of the invention.

FIG. 12 is a perspective view showing an embodiment of an alignment mechanism used with the package and blind of the invention.

FIG. 13 is a plan view of the alignment mechanism of FIG. 12.

FIG. 14 is a flow diagram illustrating the process of packaging and cutting blinds of the invention.

### DETAILED DESCRIPTION OF THE EMBODIMENTS OF THE INVENTION

In this application the terms “size-in-store” and “cut-to-size” refer to blinds that are manufactured in a predetermined width that is not intended to fit a particular size window. The blinds are intentionally manufactured in a size that is wider than the windows for which the blind is intended to be used. It will be appreciated that size-in-store blinds may come in a limited number of different widths where each width is intended to be used with a range of window widths. This is done to minimize the waste that would result if only a single large width blind was used that had to be cut down to fit even the smallest window. Whether a single size blind is provided or several blind sizes are provided, the significant feature of these blinds is that they are designed to be cut to the desired size at the retail level and are not sized for use in a particular size window during the manufacturing process.

The blinds are typically cut to the specific width desired by the end user at the point of sale using cutting machines provided by the blind manufacturer. Typically the end user selects the style of blind and the retail outlet personnel use the cutting machine to cut the blind to the desired width. Cutting machines are also used by mail order suppliers to provide semi-custom blinds and the invention is intended to cover any application where blinds are manufactured that are intended to be cut to a desired size after manufacture.

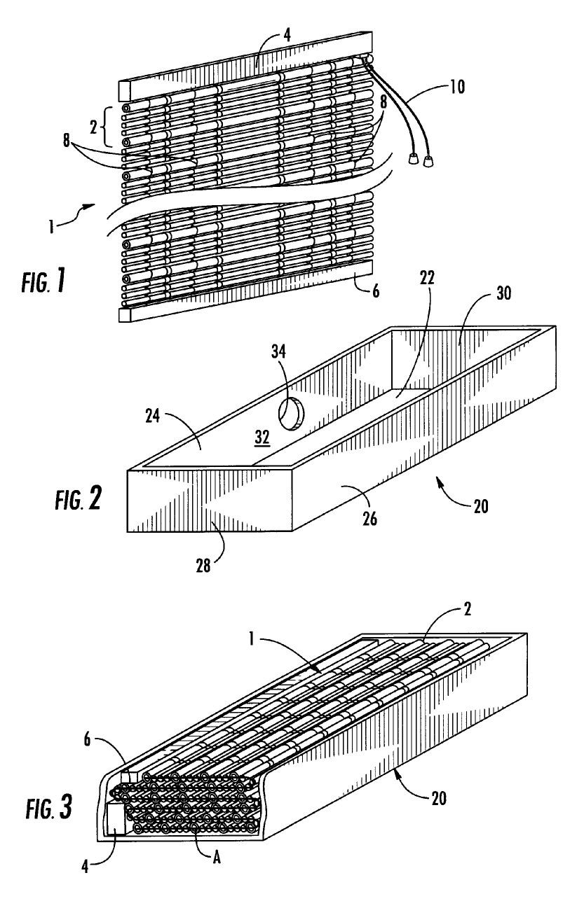

Referring to FIG. 1 an example blind construction is shown generally at 1. Blind 1 is known as a woven blind and comprises blind elements including a plurality of slats 2 connected together by cords 8 and having a head rail 4 and a bottom rail 6. It will be appreciated that in some blind styles the head rail and or the bottom rail may be omitted. The cords 8 are woven between the slats 2 to support the slats. Lift cords 10 may be provided to raise and lower the blinds as is known in the art. In one typical woven blind the slats have irregular, non-uniform outer surfaces such as bamboo canes. In a size-in-store blind the slats are made of a material that can be cut in the cutting machine such as plastic PVC that is molded to simulate the shape and look of the natural wood. The irregular outer surface of the slats exacerbates the problem of aligning the slats for cutting because the irregularly shaped slats are difficult to stack against one another. The method and apparatus of the invention is particularly well suited for blinds, such as the illustrated woven blind, where the slats are difficult to stack and hold in a desired aligned configuration. While the invention is particularly suited for such blinds it is to be understood that the method and apparatus can be used with any cut-to-size blind.

FIG. 2 shows an embodiment of the packaging used to facilitate the cutting operation. A support member comprising container 20 is provided consisting of a flat bottom wall 22 and opposed side walls 24 and 26 and opposed end walls 28 and 30. The side walls 24 and 26 and end walls 28 and 30 extend substantially perpendicularly from bottom wall 22 to create an interior space 32 for receiving the blinds. The distance between the end walls 28 and 30 is slightly longer that the width of the blind such that when blind 1 is placed in the container 20 the blind elements will be snuggly trapped between end walls 28 and 30 to fix the blind elements in the aligned position relative to one another. Moreover, the sidewalls 24 and 26 and the end walls 28 and 30 and the bottom wall 22 are dimensioned such that the blind, when loaded in container 20, will be received in interior space 32 such that the blind elements will not be able to shift positions in the box. One of side walls 24 or 26 have an aperture formed therein for aligning the blind in the cutting machine as will hereinafter be described. Container 20 is made of cardboard, pressboard, plastic or other material that can be cut using the existing cutting machines.

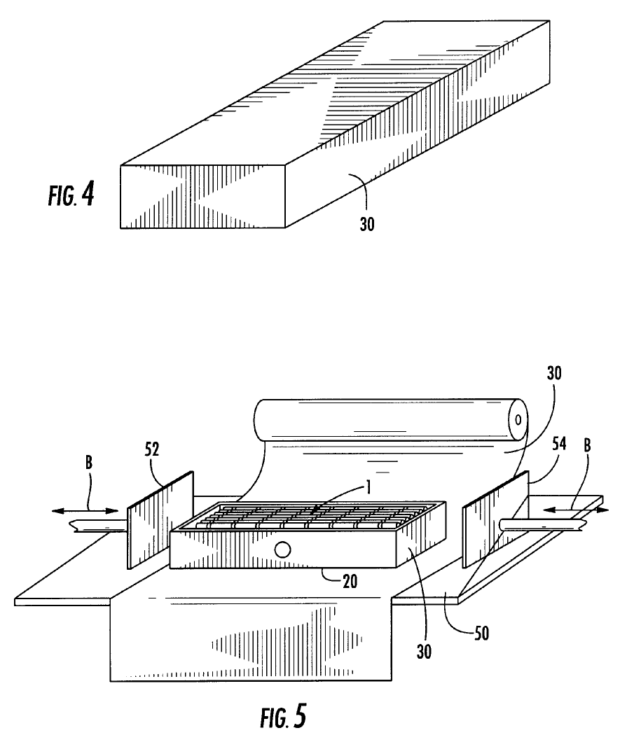

FIG. 3 shows the blind 1 loaded into the container 20 such that the blind is arranged in an overlapping configuration where each layer of blind material is folded back on top of the underlying layer as represented by S-shaped line A. Container 20 is shown with end wall 28 removed to show the blind 1 packaged in the container. After the blind 1 is loaded into the container 20, the blind is aligned such that the ends of the blind elements such as the slats, head rail and bottom rail are in a common plane. After the blind elements are aligned, the container 20 and blind 1 are wrapped in shrink wrap 30 to prevent the blind elements from moving relative to one another as shown in FIG. 3. It will be appreciated that the shrink wrap is under tension such that it exerts a compressive force on the container and blind to fix the position of the blind elements relative to the container and to fix the position of the blind elements relative to one another.

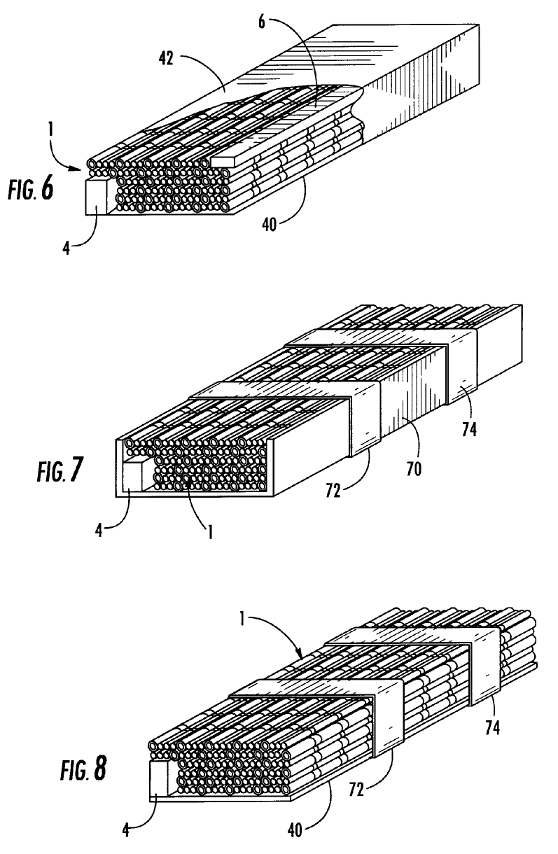

An apparatus for aligning and packaging the blinds is shown schematically in FIG. 5 and consists of a flat horizontal table 50 and a supply of shrink wrap 30. A pair of vertically disposed plates 52 and 54 are mounted to the table 50 such that the plates can be moved into and out of engagement with the end walls 28 and 30, respectively, of container 20 in the direction of arrows B. The plates 52 and 54 can be moved by pneumatic pistons or the like or manually by a hand crank. As the plates 52 and 54 are moved into engagement with the end walls 28 and 30 they exert a compressive force on the end walls that is transmitted to the blind elements such that the ends of the blind elements are forced into a common plane parallel to the plane of the plates 52 and 54. After the blind elements are aligned, the shrink wrap 30 is wrapped around the exterior of the container 20. The shrink wrap 30 is heated as is known in the art to seal and contract around the container. The pressure exerted by the shrink wrap on the container 20 is sufficient to maintain the aligned position of the blind elements.

An alternate embodiment of the packaging is shown in FIG. 6 and is the same as the embodiment of FIGS. 1 through 3 except that the support member is a planar member 40 instead of the box container 20. Planar member 40 is made of cardboard, pressboard, plastic or other material that can be cut using the existing size-in-store machines. After the ends of the slats, head rail and bottom rail are aligned in a common plane as previously described, shrink wrap 42 is used to fix the position of the blind elements in the aligned position. The shrink wrap 42 is shown partially broken away in order to show the blind 1 and support 40, it being understood that the shrink wrap 42 would completely surround the planar member 40 and blind 1.

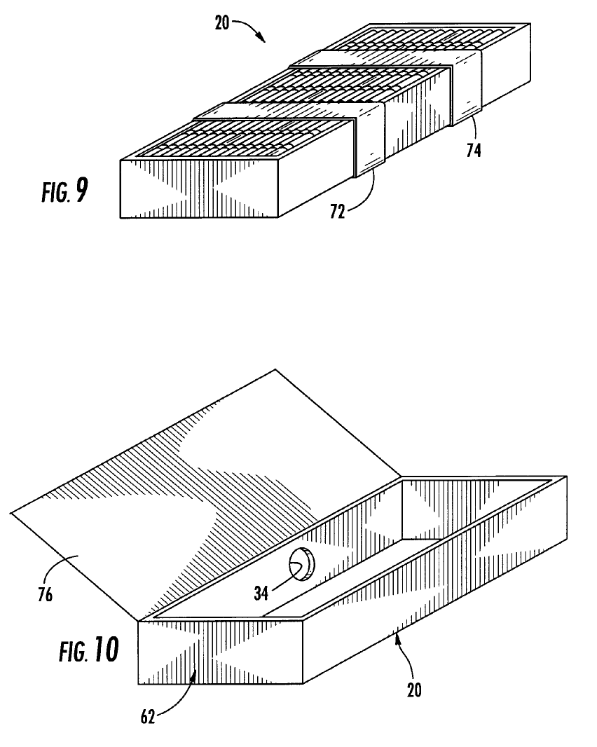

FIG. 7 shows another embodiment using a U-shaped container 70 as the support member. The shrink wrap is replaced by strapping bands 72 and 74 that are secured under tension to exert a compressive force on the container 70 to fix the blind elements in the aligned position. FIG. 8 shows the planar member 40, as described with reference to FIG. 6, used with strapping bands 72 and 74 that are secured under tension to exert a compressive force on the blind to fix the blind elements in the aligned position.

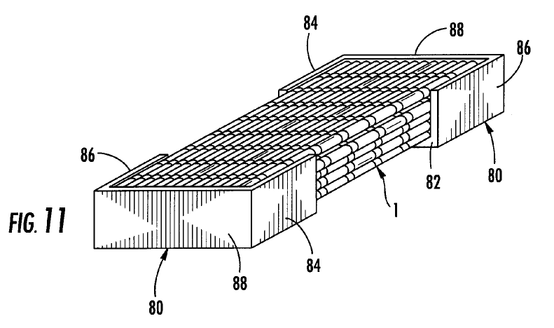

FIG. 9 shows another embodiment in which the support member consists of box container 20 as previously described with reference to FIG. 2. Strapping bands 72 and 74 are used to secure the blind in the box as previously described. Referring to FIG. 10 the support member consists of a box container 62, similar to box container 20 described with respect to FIG. 2, except that a cover 76 is provided to secure the blind 1 within the box. The cover 76 could be securely closed using adhesive or the strapping bands or shrink wrap as previously described.

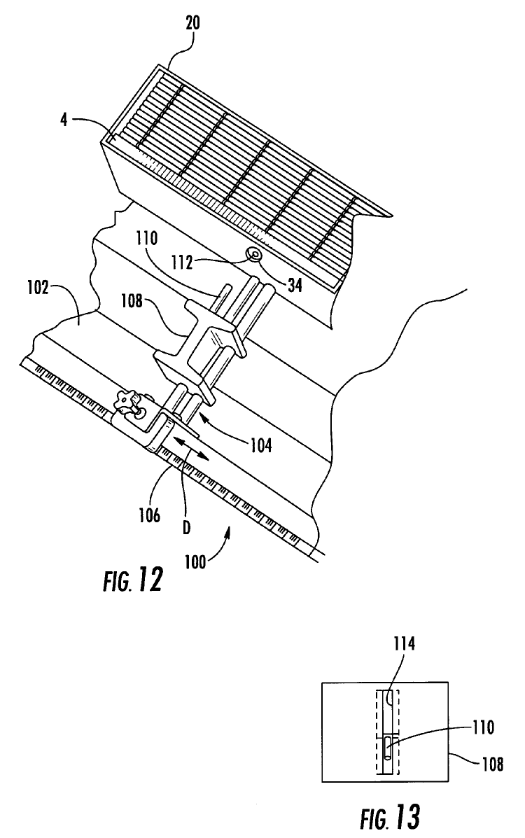

Referring to FIG. 11, another embodiment of the packaging of the invention is shown where the support member comprises an end cap 80 consisting of a planar bottom 82, opposed side walls 84 and 86 and an end wall 88 surrounds each end of blind 1. The end caps 80 extend for only a short distance of the total length of the blind 1. The slats 2, head rail and bottom rail are aligned against end walls 88, as previously described, such that they are in a common plane. Strapping bands or shrink wrap (not shown in FIG. 11) is used to secure the end caps 80 to the blind as previously described. Alternatively, the end caps 80 and blind 1 could be completely covered in shrink wrap. End caps 80 are made of cardboard, pressboard, plastic or other material that can be cut using the existing cutting machines.

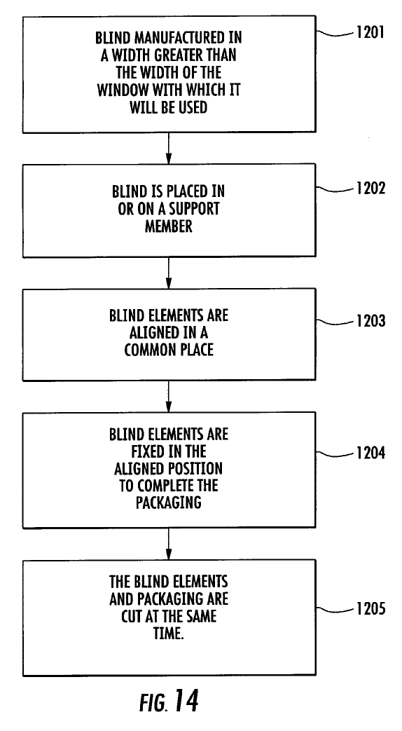

Referring to FIG. 12 an alignment device for use with the cutting machine is shown. Specifically, a portion of the existing cutting machine is shown generally at 100 including cutting table 102 having a measuring device 104. The measuring device 104 connects to the blind and is used in conjunction with a graduated rule 106 where measuring device 104 can slide on table 102 as represented by arrow D to locate the blind relative to rule 106 to measure the amount of blind to be cut off by the cutting machine. In the existing system a clip on the blind head rail mounts directly to the measuring device to fix the blind relative to the measuring device. With the package of the invention the existing system cannot operate because the blind is packaged within the packaging of the invention when located in the cutting machine. To accommodate the packaging of the invention, aperture 34 is provided in the container to allow access to the head rail 4 of the blind located in the packaging. The head rail 4 has a centrally located hole 112 formed therein that is aligned with aperture 34 when the blind is placed in container 20. The blind and container placed in the cutting machine as shown in FIG. 12 would be covered in shrink wrap or secured by strapping bands as previously described. An I-clip 108 is designed to mount onto the measuring device 104 and includes a finger 110 that extends from the I-clip to engage the hole 112 formed in the head rail. As best shown in FIG. 13, the finger 110 has a T-shape and is mounted in a slot 114 formed in the end of I-clip 108 such that the finger 110 can pivot and move up and down in slot 114 relative to the I-clip. The pivoting and sliding movement of the finger 110 allows the finger to engage the hole 112 when different size head rails are used or when the vertical location of the hole varies slightly. When the package is wrapped in shrink wrap 30, finger 110 punctures the shrink wrap to engage the hole 112. When planar support 40 or end caps 80 are used as the support, there is no need for the aperture 34 as the head rail is not covered by these supports.

Operation of the method of the invention will now be described with reference to the flow chart of FIG. 14. The blind is manufactured in a width greater than the range of window sizes for which it is intended to be used, block 1201. The blind is placed in or on a support member, block 1202. The blind elements such as the slats, head rail and bottom rail are aligned so that the ends of these elements are in a common plane, block 1203. The blind elements are fixed relative to one another in the aligned position by shrink wrap or strapping bands to complete the packaging, block 1204. The blind and the packaging are inserted into the cutting machine as a unit and both the blind elements and packaging are cut simultaneously such that the blinds are cut while held in the aligned position by the packaging, block 1205.

While embodiments of the invention are disclosed herein, various changes and modifications can be made without departing from the spirit and scope of the invention. The scope of the invention is indicated in the appended claims, and all changes that come within the meaning and range of equivalents are intended to be embraced therein.

What is claimed is:

1. Packaging for a cut-to-size blind having a plurality of blind elements comprising;
a support member for supporting the blind elements in an aligned position; and
a securing member for fixing the blind elements in the aligned position.

2. The packaging of claim 1 wherein the support member comprises a U-shaped container.

3. The packaging of claim 1 wherein the support member comprises a planar member.

4. The packaging of claim 1 wherein the support member comprises a box.

5. The packaging of claim 1 wherein the support member comprises a box having a top.

6. The packaging of claim 1 wherein the support member comprises an end cap that extends for less than the length of the blind elements.

7. The packaging of claim 1 wherein the securing member exerts a compressive force on the blind elements.

8. The packaging of claim 1 wherein the securing member exerts a compressive force on the blind elements and support member.

9. The packaging of claim 1 wherein the securing member comprises shrink wrap.

10. The packaging of claim 1 wherein the securing member comprises strapping bands.

11. The packaging of claim 9 wherein the shrink wrap completely surrounds the blind elements and support member.

12. A method for cutting a blind in a cutting machine comprising:
supporting the blind elements in an aligned position; fixing the blind elements in the aligned position separate from the cutting machine; and cutting the blind elements while fixed in the aligned position.

13. The method of claim 12 aligning blind elements such that the ends of the blind elements are in a common plane.

14. The method of claim 12 wherein the step of supporting includes supporting the blind on a support member and the step of cutting includes the step of cutting the support member.

15. The method of claim 12 wherein the step of fixing includes the step of applying a compressive force on the blind elements.

16. The method of claim 12 wherein the step of fixing includes the step of shrink wrapping the blind elements.

17. The method of claim 12 wherein the step of fixing includes the step of strapping the blind elements.

18. The method of claim 12 wherein the head rail is fixed to the cutting machine.
